(19) United States
(12) Patent Application Publication
(10) Pub. No.: US 2006/0189708 A1
(43) Pub. Date: Aug. 24, 2006

(54) Benzylsilyl(meth)acryloyl-containing polymers for marine coating compositions

(76) Inventors: Michael Abrams, Philadelphia, PA (US); Mark Aubart, Malvern, PA (US); Gary Silverman, Chadds Ford, PA (US)

Correspondence Address: Thomas F. Roland, Esq.;Arkema Inc., 2000 Market St., Philadelphia, PA, 19103, US

(21) Appl. No.: 11/065,534

(22) Filed: Feb. 24, 2005

(51) Int. Cl. C09D 5/16

(52) U.S. Cl. 523/122

(57) ABSTRACT

This invention relates to polymers for self-polishing marine antifouling coatings. More particularly, the invention relates to polymer binders, which provide an erosion rate in seawater that is suitable for use in marine antifouling coatings. These polymer binders contain pendant benzylsilylacrylate groups. Additionally it was found that marine antifouling coatings could be formed with lower silyl acrylate levels using the monomers of the invention, and still achieve a suitable erosion rate in seawater.

### FIELD OF THE INVENTION

This invention relates to polymers for self-polishing marine antifouling coatings. More particularly, the invention relates to polymer binders, which provide an erosion rate in seawater that is suitable for use in marine antifouling coatings. These polymer binders contain pendant benzylsilylacrylate groups. Additionally it was found that marine antifouling coatings could be formed with lower silyl acrylate levels using the monomers of the invention, and still achieve a suitable erosion rate in seawater.

### BACKGROUND OF THE INVENTION

The most effective polymers used to fabricate self-polishing marine antifouling coatings are polymers that contain pendant organotin ester (e.g., acrylate) groups. Indeed, marine antifouling coatings based on organotin acrylate polymers have dominated the market for over 20 years. The organotin acrylate-containing polymers, when formulated into a coating and applied to the bottom (i.e., hull) of a marine vessel, hydrolyze in seawater to release an organotin compound (usually tributyltin oxide) that is an active antifoulant, preventing marine plants and other organisms from adhering to the vessel bottom. This fouling (i.e., undesirable attachment of organisms to a marine surface) results in increased drag which can significantly increase fuel consumption and, therefore, operating costs. In addition, movement of the vessel through water erodes the coating surface to constantly expose a fresh polymer surface to the hydrolytic effect of seawater. This constant erosion of the coating surface results in the development and maintenance of a smooth surface on the immersed exterior of the marine vessel, which also contributes to reduced drag and greater efficiency.

Further, these coatings, if properly formulated and applied, have the ability to remain effective for 5 years. This is important because large vessels (e.g., oil tankers and container ships) are dry-docked at 5-year intervals for routine maintenance and inspection; it is most convenient to recoat the hull exterior during these periodic maintenance episodes.

Although effective, the use of organotin-containing polymers in antifouling marine coatings has come under attack due to the adverse effect that organotin compounds are believed to have upon the marine environment. The U.S. Environmental Protection Agency (EPA) has significantly restricted the continued use of organotin compounds and the Marine Environmental Protection Committee (MEPC) of the International Maritime Organization (IMO), a unit of the United Nations, has recently approved a resolution to phase out and eventually prohibit the use of organotin-containing materials in antifouling coatings.

As a result, there is a need in the art for improved erodible antifouling coating compositions comprising film-forming polymers that are free of tin, while retaining the good antifouling and self-polishing properties as well as the longevity of the organotin-containing antifouling coatings.

One solution has been the use of anti-fouling coatings containing organosilylacrylate units, such as those described in U.S. Pat. Nos. 4,593,005 and 5,436,284; and in EP 1 127 925. The coating compositions shown in the Examples of these references contain the organosilylacrylate component in amounts ranging from 15 to 40 mole percent.

U.S. Pat. No. 5,795,374 discloses marine antifoulant coatings formulated from polymers containing triorganosilyl groups. Additional patents disclosing triorganosilyl containing polymers as binders for marine antifouling coatings include: JP 63-057676 which discloses adding a polymethyl silsesquioxane powder for stability when the coating has copper containing antifoulant compounds; U.S. Pat. No. 5,767,1711 which discloses a copolymer containing a triorganosilylacrylate and as an essential ingredient a monomer containing an acryloyloxy, a methacryloyloxy, maleinoyloxy, or fumaroyloxy group; U.S. Pat. No. 5,795,374 which discloses a marine antifouling coating having an organosilylacrylate based polymeric binder and a rosin compound to improve the erosion rate of the coating. The following listed patents and applications further disclose polymers comprising triorganosilyl pendant groups useful as binders in marine antifouling coatings: EP 0775733A1, U.S. Pat. No. 6,458,878, JP 8-269389A, U.S. Pat. No. 4,594,365, U.S. Pat. No. 5,436,284, U.S. Pat. No. 5,795,374, U.S. Pat. No. 6,172,132, WO 84/02915, WO 91/14743, WO 0077102A1.

U.S. patent application Ser. No. 10/442,461 (2003-0225184) and Ser. No. 10/705,693 (2003-0109597) describe triarylsilyl(meth)acryloyl-containing polymers for marine coating compositions.

Unfortunately, commonly observed performance problems with silyl-containing copolymers are premature cracking and lack of control over erosion behavior (e.g. no erosion, rapid erosion, or ablative behavior). These deficiencies render the coatings unsuitable for marine antifoulant applications.

Surprisingly, it has now been found that the incorporation of low levels of benzylsilyl-containing monomers into the polymer binder produces polymers exhibiting desirable erosion characteristics that are different from previously synthesized polymers derived from triaryl- and trialkylsilyl(meth)acrylate monomers. The benzylsilyl-polymers exhibit a complex and unusual relationship between silyl-monomer content and erosion behavior. The consequences of this composition/performance response are that high-performance self-polishing coatings may be obtained from copolymers with dramatically reduced levels of (often expensive) silyl-containing monomers.

### SUMMARY OF THE INVENTION

An objective of the invention is to obtain self-polishing coatings with controlled erosion characteristics using polymer binders having a low mole percent silyl-monomer. Another objective of the invention is to optimize the marine anti-fouling properties of a benzylsilyl-containing polymer binder.

Still another objective of the invention is to characterize the benzylsilyl-containing polymer binders of the invention in a manner that a binder having a predictable erosion rate can be formulated.

The objects of the invention are met by a polymer composition useful as a binder in a marine antifoulant coating comprising as monomer units:

a) 0.01 to 20 mole percent of one or more substituted or unsubstituted benzylsilyl(meth)acrylate units; and

b) 80 to 99.99 mole percent of one or more ethylenically unsaturated monomer units copolymerizable with the benzylsilyl(meth)acrylate units.

The objectives are further met by a self-polishing marine antifouling coating composition comprising the polymer of claim 1, a toxicant, and a stabilizing agent.

### BRIEF DESCRIPTION OF THE DRAWINGS

FIGS. 1 and 2 illustrate the rotor test apparatus used to determine erosion rate.

FIG. 3 illustrates the relationship between mole percent tribenzylsilylmethacrylate (TBzSMA) residue in a polymer and the erosion rate in seawater of the polymer and compares those erosion rates with that of a triorganotin-based polymer. Each benzyl group can be substituted or un-substituted.

FIG. 4 shows the average erosion rate for 5- and 15-mole percent tribenzylsilylmethacrylate-containing copolymers, and a typical triorganotin based polymer. Note the higher erosion rate for the 5 mole percent TBzSMA sample.

FIG. 5 shows R² data for 5 and 15 mole percent tribenzylsilylmethacrylate-containing polymers, and a comparative triorganotin based polymer, showing excellent erosion linearity over the length of the study.

### DETAILED DESCRIPTION OF THE INVENTION

The invention relates to the use of benzylsilyl(meth)acrylate copolymers containing low levels of the benzylsilyl monomer for use as binders for marine anti-fouling coatings having self-polishing properties.

By benzylsilyl(meth)acrylate monomers is meant a monomer having the structure XSiR₃, where X is an acryloxy or methacryloxy group, and at least one R is a substituted or unsubstituted benzyl group, and the other R groups being the same or different, and selected from the group of substituted or unsubstituted benzyl groups, substituted or unsubstituted alkyl or aryl groups, or H. As used herein, the term benzylsilyl(meth)acrylate is meant to encompass both benzylsilylacrylates and benzylsilylmethacrylates. The benzylsilyl(meth)acrylate monomers of the invention may also be a mixture of two or more different monomers. The benzylsilyl(meth)acrylate monomers may be substituted or unsubstituted. Examples of benzyl substituents R of benzylsilyl(meth)acrylate monomers or residues XSiR₃ [X=acrylate, methacrylate, acrylate residue, methacrylate residue] useful in the present invention include, but are not limited to, benzyl, 2-chlorobenzyl, 2-fluorobenzyl, 2-methylbenzyl, 3-fluorobenzyl, 3-chlorobenzyl, 3-methylbenzyl, 4-fluorobenzyl, 4-methylbenzyl, 4-(tert-butyl)benzyl, 2-(trifluoromethyl)benzyl, 4-(trifluoromethyl)benzyl, 2,6-difluorobenzyl, 2,3-difluorobenzyl, 2-chloro-6-fluorobenzyl, 2,4-difluorobenzyl, 2,5-difluorobenzyl, 2,5-dimethylbenzyl, 2,4-dimethylbenzyl, 2,4-dichlorobenzyl, 3,4-dichlorobenzyl, 3,5-difluorobenzyl, 2,4,6-trimethylbenzyl, 2,3,4,5,6-pentafluorobenzyl, 2,3,5,6-tetrafluoro-4-(trifluoromethyl)benzyl, 2,4-bis(trifluoromethyl)benzyl, 3,5-bis(trifluoromethyl)benzyl, 2-phenylbenzyl.

The copolymer formed is of the form -[A]-[B]- where A comprises one or more XSiR₃ wherein each R may be the same or different and represents a substituted or unsubstituted alkyl, aryl, heteroalkyl, or heteroaryl group, or H, and at least one R is a substituted or unsubstituted benzyl group, where X is the residue of a methacryloxy or acryloxy group, and where B represents the residue of one or more ethylenically unsaturated monomers copolymerizable with A. Both direct and post-functionalized polymers are contemplated by the invention.

The benzylsilyl(meth)acrylate monomer is present at from 0.01 to 20 mole percent, based on the total monomer units present in the polymer. Polymers utilizing greater than 20 mole % silyl-containing monomer exhibited cracking within 45-days of the commencement of erosion testing. Polymers with less than 20 mole %, silyl-containing monomer exhibited excellent self-polishing behavior. A reduction in the amounts of silyl-containing monomer was found to result in increasing erosion rate, with a maximum erosion rate observed at surprisingly low silyl-monomer levels. It was found that a 5 mole percent tribenzylsilylmethacrylate copolymer coating had a faster erosion rate than a 15 mole percent copolymer.

The benzylsilyl(meth)acrylate monomer(s) are copolymerized with one or more ethylenically unsaturated monomers that are copolymerizable therewith to form a copolymer. By “copolymer” as used herein is meant polymers comprising two or more different monomeric units, e.g. polymers containing three or more different monomeric units, also known as terpolymers. Also, in practicing the present invention, mixtures of polymers may be used in antifouling coating compositions with the proviso that the total of the benzylsilyl(meth)acrylate is greater than 0.01 mole percent and less than 20 mole percent for the mixture of polymers even though each individual polymer may be outside the mole percent range. The properties of the copolymer can be modified by adding hydrophilic or hydrophobic functionality by way of the monomer or monomers used to form the copolymer.

Useful comonomers include, but are not limited to: the esters of acrylic acid such as methyl acrylate, ethyl acrylate, propyl acrylate, n-butyl acrylate, t-butyl acrylate, sec-butyl acrylate, 2-ethylhexyl acrylate, cyclohexyl acrylate, phenyl acrylate, n-octyl acrylate, 2-hydroxyethyl acrylate, hydroxy-n-propyl acrylate, hydroxy-i-propyl acrylate, glycidyl acrylate, 2-methoxyethyl acrylate, 2-methoxypropyl acrylate, methoxytriethyleneglycol acrylate, 2-ethoxyethyl acrylate, ethoxydiethyleneglycol acrylate, and the esters of methacrylic acid such as methyl methacrylate, ethyl methacrylate, propyl methacrylate, n-butyl methacrylate, t-butyl methacrylate, sec-butyl methacrylate, 2-ethylhexyl methacrylate, cyclohexyl methacrylate, 2-hydroxyethyl methacrylate, glycidyl methacrylate, 2-methoxyethyl methacrylate, 2-methoxypropyl methacrylate, methoxytriethyleneglycol methacrylate, and 2-ethoxyethyl methacrylate, hydroxy-n-propyl methacrylate, hydroxy-i-propyl methacrylate, phenoxyethyl methacrylate, butoxy ethyl methacrylate, isobomyl methacrylate. Other useful ethylenically unsaturated monomers include neopentyl glycolmethylether propoxylate acrylate, poly(propylene glycol) methylether acrylate, ethoxydiethyleneglycol methacrylate, acrylic acid, methacrylic acid, 2-butoxyethyl acrylate, crotonic acid, di(ethylene glycol) 2-ethylhexyl ether acrylate, di(ethylene glycol) methyl ether methacrylate, 3,3-dimethyl acrylic acid, 2-(dimethylamino) ethyl acrylate, 2-(dimethylamino) ethyl methacrylate, ethylene glycol phenyl ether acrylate, ethylene glycol phenyl ether methacrylate, 2(5H)-furanone, hydroxybutyl methacrylate, methyl-2(5H)-furanone, methyl trans-3-methoxyacrylate, 2-(t-butylamino)ethyl methacrylate, tetrahydrofurfuryl acrylate, 3-tris-(trimethylsiloxy)silyl propyl methacrylate, tiglic acid, and trans-2-hexenoic acid.

Other examples of polymerizable monomers include vinyl esters such as vinyl acetate, vinyl propionate, vinyl butyrate, vinyl benzoate, maleic esters such as dimethyl maleate, diethyl maleate, di-n-propyl maleate, diisopropyl maleate, di-2-methoxyethyl maleate, fumaric esters such as dimethyl ftimarate, diethyl fumarate, di-n-propyl fumarate, diisopropyl fumarate, styrene, vinyltoluene, alpha-methylstyrene, N,N-dimethyl acrylamide, N-t-butyl acrylamide, N-vinyl pyrrolidone, and acrylonitrile.

Additional monomers useful in the production of polymers of the invention include: silyl(meth)acrylates such as trimethylsilyl(meth)acrylate, diphenylmethylsilyl(meth)acrylate, phenyldimethylsilyl(meth)acrylate, triisopropylsilyl(meth)acrylate, tributylsilyl(meth)acrylate, triphenylsilyl(meth)acrylate, tri(p-tolyl)silyl(meth)acrylate, tri(m-tolyl)silyl(meth)acrylate, tri[4-(trifluoromethyl)phenyl]silyl(meth)acrylate, and tri(3,4-difluorophenyl)silyl(meth)acrylate.

The polymers of the present invention may be prepared by polymerizing benzylsilyl(meth)acrylate with one or more ethylenically unsaturated monomers which are copolymerizable therewith. Specific monomers have been discovered to be useful in synthesizing terpolymers or higher polymers of the present invention to provide polymers with improved properties such as film flexibility and crack resistance, while retaining acceptable water erodibility.

A random benzylsilyl(meth)acrylate polymer can be obtained by polymerizing the mixture of monomers in the presence of a free-radical olefinic polymerization initiator or catalyst using any of various methods such as solution polymerization, bulk polymerization, emulsion polymerization, and suspension polymerization using methods well-known and widely used in the art. In preparing a coating composition from the polymer, it is advantageous to dilute the polymer with an organic solvent to obtain a polymer solution having a convenient viscosity. For this, it is also desirable to employ the solution polymerization method or bulk polymerization method.

Examples of useful organic solvents include aromatic hydrocarbons such as xylene and toluene, aliphatic hydrocarbons such as hexane and heptane, esters such as ethyl acetate and butyl acetate, alcohols such as isopropyl alcohol and butyl alcohol, ethers such as dioxane and tetrahydrofuran, and ketones such as methyl ethyl ketone and methyl isobutyl ketone. The solvents are used either alone or in combination.

The benzylsilyl-containing copolymer may be formulated with a toxicant to form a self-polishing antifouling marine coating. Said polymer is characterized by an erosion rate in seawater of 0.1 to 15 microns/month. The amounts of benzylsilyl(meth)acrylate monomer can be selected and adjusted within the range of 0.01 to about 20 mole percent of the polymer to provide a polymer having an erosion rate of from about 0.1 to about 15 microns/month, preferably from about 0.5 to about 9 microns/month and optimally from about 0.5 to about 7 microns/month. Also preferred is a polymer that provides a reasonably uniform erosion rate for the marine antifouling coating.

The desirable molecular weight of the benzylsilyl(meth)acrylate-containing polymer thus obtained is in the range of from 1,000 to 200,000 g/mol, preferably from 5,000 to 150,000 g/mol in terms of weight-average molecular weight. Too low or too high molecular weight polymers create difficulties in forming normal coating films. Too high molecular weights result in long, intertwined polymer chains that do not perform properly and result in viscous solutions that need to be thinned with solvent so that a single coating operation results in a thin film coating. Too low molecular weight polymers require multiple coating operations and provide films that may lack integrity and do not perform properly. It is advantageous that the viscosity of the solution of the polymer is 200 to 6,000 centipoise at 25° C. To achieve this, it is desirable to regulate the solid content of the polymer solution to a value in the range of from 5 to 90% by weight, desirably from 15 to 85% by weight.

The toxicant used in the coating composition of the present invention may be any of a wide range of conventionally known toxicants. The known toxicants are roughly divided into inorganic compounds, metal-containing organic compounds, and metal-free organic compounds.

Examples of inorganic toxicant compounds include copper compounds such as cuprous oxide, copper powder, copper thiocyanate, copper carbonate, copper chloride, and copper sulfate, and zinc and nickel compounds such as zinc sulfate, zinc oxide, nickel sulfate, and copper-nickel alloys.

Examples of metal-containing organic toxicant compounds include organocopper compounds, organonickel compounds, and organozinc compounds. Examples of organocopper compounds include oxine copper, copper nonylphenolsulfonate, copper bis (ethylenediamine) bis (dodecylbenzenesulfonate), copper acetate, copper naphthenate, cuprous pyrithione, and copper bis (pentachlorophenolate). Examples of organonickel compounds include nickel acetate and nickel dimethyldithiocarbamate. Examples of organozinc compounds include zinc acetate, zinc carbamate, zinc dimethyldithiocarbamate, zinc pyrithione, and zinc ethylenebis (dithiocarbamate).

Examples of metal-free organic toxicant compounds include N-trihalomethylthiophthalimides, dithiocarbamic acids, N-arylmaleimides, 3-(substituted amino)-1,3-thiazolidine-2,4-diones, dithiocyano compounds, triazine compounds.

Examples of N-trihalomethylthiophthalimide toxicants include N-trichloromethylthiophthalimide and N-fluorodichloromethylthiophthalimide. Examples of dithiocarbamic toxicants include bis (dimethylthiocarbamoyl) disulfide, ammonium N-methyldithiocarbamate, and ammonium ethylenebis (dithiocarbamate).

Examples of arylmaleimide toxicants include N-(2,4,6-trichlorophenyl)maleimide, N-4-tolylmaleimide, N-3-chlorophenylmaleimide, N-(4-n-butylphenyl)maleimide, and N-anilinophenyl)maleimide.

Examples of 3-(substituted amino)-1,3-thiazolidine-2,4-dione toxicants include 3 benzylideneamino-1,3-thiazolidine-2,4-dione, 3-4(methylbenzylideneamino), 1,3-thiazolidine-2,4-dione, 3-(2-hydroxybenzylideneamino-1,3-thiazolidine-2,4-thiazolidine-2,4-dione, 3-(4-dichlorobenzylideneamino)-1,3-thiazolidine-2,4-dione and 3-(2,4-dichlorobenzylideneamino-1,3-thiazolidine-2,4-dione.

Examples of dithiocyano toxicant compounds include dithiocyanomethane, dithiocyanoethane, and 2,5-dithiocyanothiophene. Examples of the triazine compounds include 2-methylthio-4-t-butylamino-6-cyclo-propylamino-s-triazine.

Other examples of metal-free organic toxicant compounds include 2,4,5,6-tetrachloroisophthalonitrile, N,N-dimethyldichlorophenylurea, 4,5-dichloro-2-n-octyl-4-isothiazoline-3-one, N,N-dimethyl-N′-phenyl-(N-fluorodichloromethylthio)sulfamide, tetramethylthiuram disulfide, N-cyclopropyl-N′-(1,1-dimethylethyl)-6-(methylthio)-1,3,5-triazine-2,4-diamine, dichlorofluanid, pyridine-triphenyl-boron, tertachloroisophthalonitrile, 3-iodo-2-propylbutyl carbamate, 2-(methoxycarbonylamino)benzimidazole, 2,3,5,6-tetrachloro-4-(methylsulfonyl)pyridine and diiodomethyl-p-tolyl sulfone.

One or more toxicants, which may be selected from the foregoing toxicants, can be employed in the antifoulant coating composition. The toxicant is used in an amount from 0.1 to 80% by weight, preferably from 1 to 60% by weight of the coating composition. Too low toxicant levels do not produce an antifouling effect, while too large a toxicant level can result in the formation of a coating film which is liable to develop defects such as cracking and peeling, thereby becoming less effective.

Additive ingredients may optionally be incorporated into the coating composition of the present invention. Examples of such additive ingredients are colorants such as pigments (e.g., red iron oxide, zinc oxide, titanium dioxide, talc), and dyes, stabilizers, dehumidifiers, and additives ordinarily employed in coating compositions such as antisagging agents, antiflooding agents, antisettling agents, and antifoaming agents.

Benzylsilyl(meth)acrylate polymers and coating compositions made from these polymers may increase in viscosity during storage. To prevent an unsatisfactory viscosity increase, materials known as “stabilizers” may be added during or after polymerization or may be incorporated into the coating composition. Stabilizing materials include inorganic dehydrating agents, such as molecular sieves or anhydrous calcium sulfate; organic dehydrating agents, such as orthoesters; bases, such as amino compounds; water reactives, such as alkoxy silanes; chelating agents, such as tris(nonylphenyl)phosphite; and hindered phenol antioxidants, such as butylated hydroxy toluene (BHT). Other useful stabilizers include triorgano phosphites, triorgano amines, heteroaromatic nitrogen compounds, maleic anhydride, and carbodiimides. In normnal use, the stabilizer level is 0.1 to 10 weight percent based on the coating composition.

Rosin and rosin derivatives may be added to the coating composition as part of the binder system. Rosin and rosin derivatives are preferably present in the range of 0.5 to 60 weight percent of the polymer, preferably 10 to 30 weight percent for the purpose of assisting in controlling water penetration into the coating film.

For applying the marine antifouling coating compositions made from the benzylsilyl(meth)acrylate polymers of the present invention onto the surface of a marine vessel, the coating composition is applied to the surface in a suitable manner (such as by brushing or spraying) and the solvent is removed by evaporation at ambient temperature or with heating. By this method, a dry coating film of suitable thickness can be easily formed on the surface of the vessel.

In addition to marine antifouling applications, the antifouling coating composition of the invention may also be used in fresh water and brackish water applications.

There are many potential advantages to the use of low silyl-content copolymers. Use of low percentages of silyl-monomer generates films with improved erosion behavior relative to their high mole percent analogues. One example of this improvement is the observation that copolymers with≧20 mole percent tribenzylsilylmethacrylate (TBzSMA) copolymers cracked, whereas<20 mole percent TBzSMA copolymers do not crack under identical conditions.

The overall erosion performance (ER, R², resistance to cracking) of the benzylsilyl-containing polymers differs considerably from previously synthesized polymers. The vast majority of previously reported silylacrylate-based binders require high (>45 mole %) silyl incorporation in order to deliver acceptable erosion performance. Table 1 details the differences in erosion behavior between TBzSMA polymers and copolymers derived from simple alkylsilyl(meth)acrylate- and arylsilyl(meth)acrylate-derived binders that successfully utilize low mole % [Si].

TABLE 1

| | Resistance to | 65-Day Erosion |
|---|---|---|
| Reference | Cracking | Rate Behavior |
| This patent | Cracking observed at | Increasing erosion rate with |
| | [benzylsilyl(meth) | increase in [Si] content |
| | acrylate] >20 mole % | from 5 to 15 mole %; 65-day |
| | | data not available on polymers |
| | | with 10 or >15 mole % [Si] |
| US20030109597 | Cracking observed for | Exemplified polymers show |
| | exemplified polymers | decreasing erosion rate with |
| | at [Si] >20 mole % | decreasing [Si] |
| | | incorporation observed in |
| | | 0-25 mole % range |
| US20040138332 | No cracking observed | Exemplified polymers show |
| | for exemplified | increasing erosion rate with |
| | polymers in 5-45 | decreasing [Si] |
| | mole % [Si] range | incorporation in 37-11 |
| | | mole % [Si] range; |
| | | maximum erosion rate |
| | | at ˜11 mole % [Si]; |
| | | decreasing erosion rate with |
| | | decreasing [Si] content |
| | | below 11 mole % [Si] |

Although the crack-resistance of the low mole % benzylsilyl-containing polymers is similar to exemplified systems, the erosion rate behaviors of the two systems are entirely different: in contrast to the exemplified polymers in US20030109597, a decrease in (potentially expensive) silyl monomer content for the TBzSMA-MMA system results in an increase in erosion rate (15 mole % TBzSMA: 1.8 microns/month; 5 mole % TBzSMA:3.4 microns/month).

The TBzSMA erosion rate-composition relationship shows some similarities to the exemplified system in US20040138332 which exhibited decreasing erosion rate as [Si] decreased from 37 to 11 mole %, a maximum erosion rate at 11 mole %, and then decreasing erosion rate with decreasing [Si] content below 11 mole %. Different (and superior) compared to the exemplified polymers in US20040138332, however, is the fact that although the highest TBzSMA erosion rate was observed for the TBzSMA polymer with the lowest [Si] content tested, the maximum erosion rate for the exemplified polymers in US20040138332 was observed at ˜11 mole % [Si], whereas the maximum erosion rate observed thus far for TBzSMA-derived polymers was only 5 mole % [Si]. Furthermore, the absence of a mole % regime where decreasing [Si] content results in decreased erosion rate suggests that it may be possible to generate polymers with yet higher erosion rates (and continued excellent erosion linearity) through use of even lower [Si] levels (<5 mole %).

Erosion rate is not the only desired property that may be optimized using low mole percent copolymers. Other film properties, such as, but not limited to, film lifetime, erosion linearity, film flexibility, ease of processing and/or formulation, biocide compatability, storage lifetime (shelf-life), adhesion, crack-resistance, and flexibility may also be affected and/or optimized using low mole percent benzylsilyl-monomer copolymers.

The use of low mole percent silyl-monomer copolymers may also have significant economic advantages. Silyl-containing monomers are often more expensive than simple acrylate monomers. The use of high performing copolymers with low levels of benzylsilyl-monomer could be advantageous economically, relative to the higher mole percent silyl-monomer analogues.

### EXAMPLES

General Polymerization Procedure

Xylene and monomers were injected into a microreactor equipped with a condenser, an inert gas/vacuum line connector, a variable speed syringe pump, septum inlet, temperature control of±2° C., and mechanical agitation. The solution was heated to 86° C. and held at that temperature for 10 minutes. The syringe pump was then turned on, and a 0.0348 M solution of initiator [2,2′-azobis(isobutyronitrile)] in xylene was added over a period of 1 hour. The reaction mixture was held at 86° C. for an additional 3 hours, whereupon the temperature was raised to 110° C. and held at this level for 15 minutes. The heating was then discontinued and the reactor was allowed to cool to room temperature. The overall molar monomer:initiator ratio was 215:1, and xylene accounted for 50 weight percent of the approximately 15 ml of reagents and solvent used in the reaction.

Rotor Test

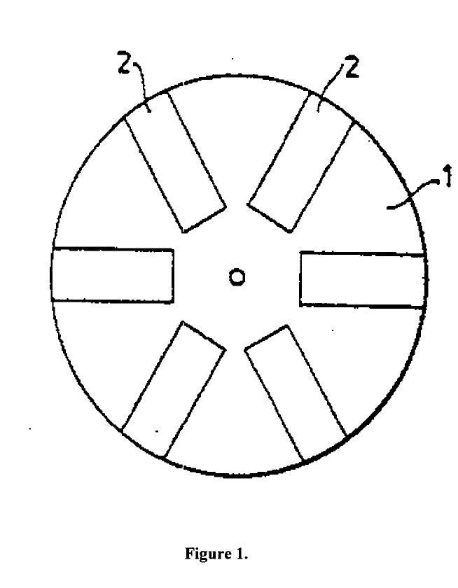

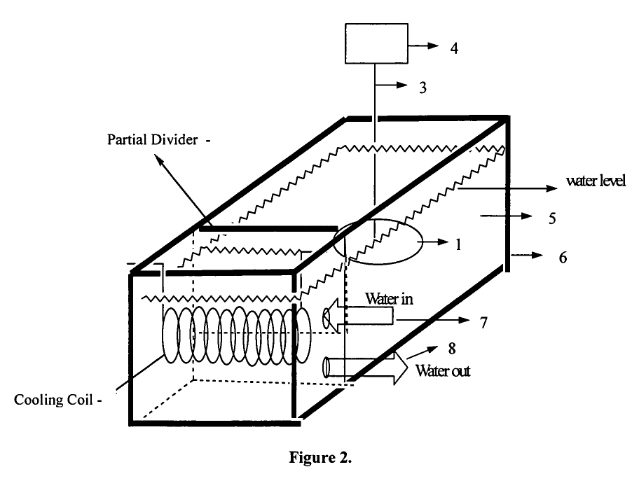

The performance of the polymers in relatively quickly moving simulated seawater was tested in the apparatus illustrated schematically in FIGS. 1 and 2 of the drawings. Referring to these Figures, a poly (methylmethacrylate) disc 1 having a diameter of 8 inches was coated with radial stripes 2 with the polymer undergoing testing being applied from an applicator adapted to deposit a film. The disc 1 was set aside to dry and the thickness of the stripes 2 was measured by contact profilometry using a Tencor Alpha Step 500 Profiler.

The disc 1 was mounted on a shaft 3 driven by an electric motor 4 and immersed in flowing seawater 5 contained in a vessel 6 having an inlet 7 and an outlet 8. A pump (not shown) is used to circulate seawater from outlet 8 through a filter (not shown) and back to vessel 6 through inlet 7. Cooling fluid is circulated through cooling coils 10 to maintain the seawater temperature. Partial divider, 9, extends from above the water surface to just below the depth of the cooling coils. The peripheral speed of the disc 1 at the measured circumference point (8.0 cm radius) was 17 knots and the seawater temperature was maintained at 20±3° C. Failure to control the test temperature has consequences. Higher temperatures result in faster erosion, while lower temperatures cause slower erosion.

During this test, the stripes were eroded away from the disc. The film thickness was measured periodically during the rotor test for each stripe at the 8.0 cm radius point and the rate of removal of polymer by erosion was determined. The Rotor Test is conducted for 65±5 days in seawater and the erosion rate is calculated in microns per month (microns/mo) from film thickness measurements as a function of time. The erosion rate in seawater so calculated is defined herein as the “Erosion Rate” and referred to as a “65 day Erosion Rate test”.

### Example 1

A series of copolymers (5-, 10-, 15-, 20-, 25-, 30-, 35-, and 40 mole % tribenzylsilyl methacrylate, H₂C═C(CH₃)C(O)OSi(CH₂C₆H₅)₃, abbreviated TBZSMA) were generated by copolymerizing TBzSMA and methyl methacrylate (MMA). All solutions were 50 weight % polymer in meta-xylene, with monomer:initiator ratios fixed at 215:1. Films from these copolymer solutions were cast on poly(methyl methacrylate) rotor discs and subjected to erosion testing in simulated seawater baths for a total of 65(±5) days.

BIOMET 304/60, a product of Arkema Inc. was tested as a comparative composition. BIOMET 304/60 is a blend of a tributyl tin methacrylate (TBTM)/methylmethacrylate (MMA) copolymer (½ by mole percent) with a TBTM/butyl methacrylate (BMA) copolymer ( 1/19 by mole %) with the ratio of the TBTM/MMA copolymer to TBTM/BMA copolymer at 45.4% to 4.6%, with the remaining 50% by weight of xylene.

Films were visually inspected, and film thicknesses were measured for each film by contact profilometry, every 3-10 days. The erosion behavior of the films could then be determined by evaluating film thickness as a function of time. The erosion rate and erosion linearity of each copolymer was determined by averaging the observed changes for multiple films cast from the same solution.

The erosion behavior of the polymers was found to exhibit a complex dependence on mole % TBzSMA.

Films derived from polymers with≧20 mole % TBzSMA were found to crack during the course of erosion testing. Polymers with 25-, 30-, 35-, and 40 mole % TBzSMA exhibited cracks visible to the naked eye within 4 weeks of the start of testing; 20 mole % TBzSMA copolymers cracked within 6 weeks. The relationship between polymer composition and time-to-creaking is shown in Table 2.

| | Mole % [TBzSMA] | Average time to Failure |
|---|---|---|
| Polymer | in copolymer | (days) |
| 1 | 5 | DNF |
| 2 | 10 | UCF |
| 3 | 15 | DNF |
| 4 | 20 | 40 |
| 5 | 25 | 27 |
| 6 | 30 | 14 |
| 7 | 35 | 27 |
| 8 | 40 | 27 |
| BIOMET 304/60 | | DNF |

Table 2. DNF=did not fail 65(±5)-day test; UCF=unable to cast film due to high viscosity

The high viscosity of polymers with 10-mole % TBzSMA rendered them unsuitable for casting as films, and thus this composition could not be evaluated by erosion testing.

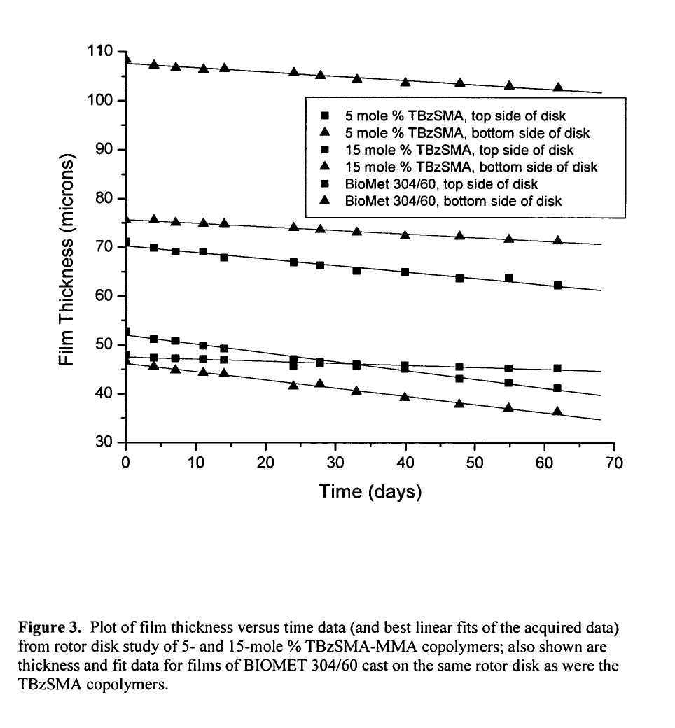

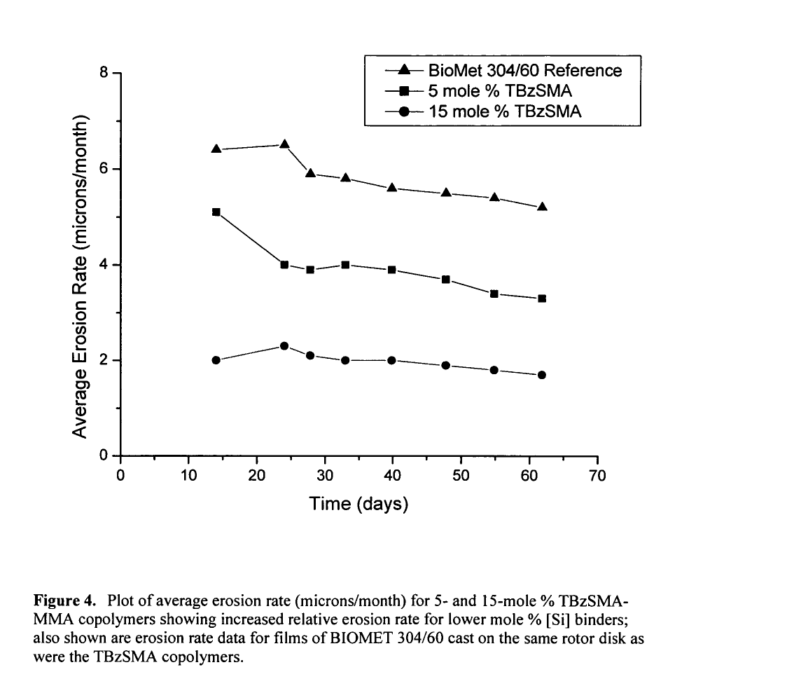

Only the copolymers with<20 mole % TBzSMA remained structurally intact throughout the 65-day testing period. Detailed thickness versus time data for these polymers is provided in FIG. 3. After 65 days, the 95-5 MMA-TBzSMA copolymer exhibited an erosion rate of 3.4 microns/mo; after the same testing period, the 85-15 MMA-TBzSMA copolymer had an erosion rate of 1.8 microns/mo. For reference, a sample of the tin-based BIOMET 304/60 polymer cast on the same disk had a 65-day erosion rate of 5.4 microns/mo. Plots of erosion rate versus time for these TBzSMA-MMA films (over the duration of the rotor disk experiment) are shown in FIG. 4, and a summary of composition-ER (and —R²) performance is provided in Table 3.

TABLE 3

| | | | Average |
|---|---|---|---|
| | Mole % [TBzSMA] | Average 65(±5)-day | 65(±5)-day |
| Polymer | in copolymer | ER(microns/month) | R² |
| 1 | 5 | 3.4 | 0.97 |
| 3 | 15 | 1.8 | 0.94 |
| BIOMET | | 5.4 | 0.99 |
| 304/60 | | | |

Although the highest TBzSMA erosion rate was observed for the binder with the lowest [Si] incorporation (5 mole %), the absence of a composition range where decreasing TBzSMA content results in decreasing erosion rate suggests that it may be possible to further increase the erosion rate by synthesizing polymers with even lower (<5 mole %) silyl content.

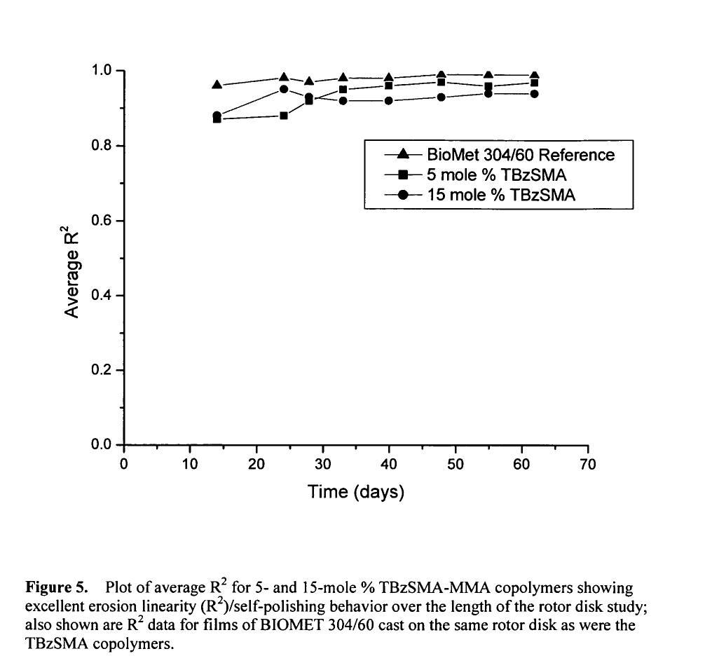

The tribenzylsilyl-containing polymers that did not crack during the 65-day test exhibited excellent self-polishing behavior throughout the rotor disk experiment, as evidenced by the high R² values (Pearson product moment correlation coefficient for the best linear fits of the film thickness vs. time data); at termination of the 65-day test, the 5- and 15-mole % TBzSMA copolymers exhibited average R² values of 0.97 and 0.94, respectively. Detailed plots of R² versus time are provided in FIG. 5.

What is claimed is:

1) A polymer composition useful as a binder in a marine antifoulant coating comprising as monomer units:
a) 0.01 to 20 mole percent of one or more substituted or unsubstituted benzylsilyl(meth)acrylate units; and
b) 80 to 99.99 mole percent of one or more ethylenically unsaturated monomer units copolymerizable with the benzylsilyl(meth)acrylate units.

2) The polymer composition of claim 1 comprising 3 to 15 mole percent of benzylsilyl(meth)acrylate units

3) The polymer composition of claim 1 wherein the benzylsilyl(meth)acrylate units comprise about 5 mole % benzylsilyl(meth)acrylate

4) The polymer composition of claim 1 wherein said ethylenically unsaturated monomer units comprise one or more monomer units selected from the group consisting of unsaturated organic acids, esters of acrylic acid, esters of methacrylic acid, vinyl compounds, maleic esters, and fumaric esters.

5) The polymer composition of claim 4 wherein said ethylenically unsaturated monomer units comprise methyl(meth)acrylate.

6) The polymer composition of claim 1 wherein said ethylenically unsaturated monomer units comprise two or more different monomer units.

7) The polymer composition of claim 1 wherein said polymer has a molecular weight of from 1000 to 200,000 g/mol.

8) The polymer composition of claim 1 further comprising an organic solvent.

9) The polymer composition of claim 1 further comprising a stabilizing agent selected from the group consisting of molecular sieves, anhydrous calcium sulfate, organic dehydrating agents, orthoesters, bases, amino compounds, water reactives, alkoxy silanes, chelating agents, tris(nonylphenyl)phosphite, hindered phenol antioxidants, butylated hydroxy toluene (BHT), triorgano phosphites, triorgano amines, heteroaromatic nitrogen compounds, maleic anhydride, carbodiimides, and mixtures thereof.

10) A copolymer composition useful as a binder in a marine antifoulant coating composition comprising a copolymer having the formula: -[A]-[B]-, where A is present at from 0.01 to 20 mole percent and comprises one or more XSiR₃ units, wherein each R may be the same or different and represents a substituted or unsubstituted alkyl, heteroalkyl, aryl or heteroaryl, or H, and at least one R is a substituted or unsubstituted benzyl group, where X is the residue of a methacryloxy or acryloxy group, and where B represents the residue of one or more ethylenically unsaturated monomers.

11) The copolymer composition of claim 10 wherein A is present at from 3 to 15 mole percent.

12) The copolymer composition of claim 10 wherein [B] comprises one or more monomer unit residues selected from the group consisting of residues of organic acids, esters of acrylic acid, esters of methacrylic acid, vinyl compounds, maleic esters, and fumaric esters.

13) The copolymer composition of claim 10 wherein [B] comprises two or more different monomer unit residues.

14) The copolymer composition of claim 10 wherein said copolymer has a molecular weight of from 1000 to 200,000 g/mol.

15) The copolymer composition of claim 10 further comprising an organic solvent.

16) The copolymer composition of claim 10 further comprising a stabilizing agent selected from the group consisting of molecular sieves, anhydrous calcium sulfate, organic dehydrating agents, orthoesters, bases, amino compounds, water reactives, alkoxy silanes, chelating agents, tris(nonylphenyl)phosphite, hindered phenol antioxidants, butylated hydroxy toluene (BHT), triorgano phosphites, triorgano amines, heteroaromatic nitrogen compounds, maleic anhydride, carbodiimides, and mixtures thereof.

17) A self-polishing marine antifouling coating composition comprising the polymer of claim 1, a toxicant, and a stabilizing agent.

18) The coating composition of claim 17, characterized by an Erosion Rate in sea water of from 0.5 to 15 microns per month.

19) The coating composition of claim 17, further comprising rosin or rosin derivatives.

20) The coating composition of claim 19 wherein said rosin or rosin derivative is present in the range of from 5 to 60 weight percent, based on the polymer.
